(19) United States
(12) Patent Application Publication
(10) Pub. No.: US 2021/0357458 A1
(43) Pub. Date: Nov. 18, 2021

(54) GENERATING NEAR REAL-TIME NOTIFICATIONS USING AN ASYNCHRONOUS MATCHING SYSTEM

(71) Applicant: Microsoft Technology Licensing, LLC, Redmond, WA (US)

(72) Inventors: Jingwei Wu, Foster City, CA (US); Caleb Johnson, Lakewood, IL (US); Yu Liu, Sunnyvale, CA (US); Dianxia Yang, Sunnyvale, CA (US); George James Pearman, Menlo Park, CA (US); Funing Xu, Sunnyvale, CA (US)

(21) Appl. No.: 16/877,147

(22) Filed: May 18, 2020

(51) Int. Cl. G06F 16/9038; G06Q 10/06; G06Q 10/10

(52) U.S. Cl. CPC G06F 16/9038; G06Q 10/1053; G06Q 10/063112

(57) ABSTRACT

Techniques are provided for automatically generating a real-time notification associated with a job posting. In one technique, in response to receiving a job posting, a plurality of saved searches that includes a first set of criteria and a second set of criteria is identified. For each saved search, a job posting is added to a first subset of saved searches if the job posting satisfies the first set of criteria. For each saved search of the first subset, a saved search is added to a second subset of saved searches if the job posting satisfies the second set of criteria. For each saved search of the second subset, a notification associated with the job posting is automatically sent to a computing device of a user associated with each saved search of the second subset.

### TECHNICAL FIELD

One technical field of the disclosure is generating instant notifications for career opportunities using an asynchronous matching system. Another technical field is computer-implemented nearline job processing systems.

### BACKGROUND

Receiving electronic notifications regarding important news or career opportunities are pervasive in modern life. Many career opportunities are filled within twenty-four hours of a job posting on an employment-related search engine. Data analysis has shown that the first twenty-five candidates who apply for a job have 3× chances of hearing back from a job poster (e.g., an employer). Given this, there is increasing interest and value in being able to receive fresh or new notifications without delay. The existing system, however, presents various technical challenges. For example, one existing approach to generating notifications of new job postings is a pull-based approach based on a scheduler that periodically conducts a job search. As an example, the existing system runs with a scheduler at a predetermined time, every three hours in one example, every day that causes every saved query in a search database to be performed against the job posting system. In this example, a search is triggered by a clock scheduler eight times per day. The job posting system reruns those queries on a regular basis (e.g., every three hours) based on a scheduler against a database of (e.g., new) job postings.

However, rerunning potentially thousands or millions of queries is a time-intensive process and requires many computing resources. Also, there is a potentially significant time lag for a job posting that is received immediately after a rerun of saved queries is performed. A user whose query would have been matched to the new job posting would not receive a notification until after the time period for rerunning the queries has lapsed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A is a block diagram that depicts an example job alert system, in an embodiment;

FIG. 1B is a block diagram that depicts an example nearline job processing system for processing new jobs and generating notifications, in an embodiment;

FIG. 2 is a flow diagram that depicts an example process for generating asynchronous instant notifications for career opportunities, in an embodiment;

FIG. 3 is an example user interface notification associated with a job posting, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

The present disclosure generally relates to a system and method for generating an instant notification message related to a new and fresh job posting in near real-time. “Near real-time” notification generation means that the notification is generated in response to receiving the new job posting and the generation is performed within seconds or minutes of receiving the new job posting. Such a near real-time instant notification (or “instant notification”) allows a user to receive a notification within seconds or minutes of an eligible job being posted on an employment-based platform. Specifically, once a job poster creates a new job posting in a user interface of an employment-based platform, a server initiates a network call (push) to trigger the job matching logic. The asynchronous matching system is triggered by invoking the job matching logic by polling a job database and other stream processing systems for data related to a new job posting that is newly created.

The job processing system first applies a first-pass filter to the job posting based on a set of saved criteria provided by users (e.g., searchers). The first-pass filter may include filtering based on certain attributes, such as a title, company, or geographic location. During the first-pass filtering, the job posting is compared against certain attributes of users' saved searches, each of which comprises a set of search criteria. Each of the users' saved searches that satisfies the job posting based on certain attributes (e.g., a first set of criteria) is added to a first subset of the saved searches. Only for the first subset of the saved searches, the job posting continues to be consumed in the job matching stream. For each of the first subset of saved searches, a second pass filter is applied to match the rest of the attributes that are not part of the users' first set of criteria (e.g., a second set of criteria) to the job posting. The second-pass filter may include filtering based on attributes such as job skills, job industry, education level, experience level, or job function. If the job posting satisfies the rest of the attributes of the users' criteria, then the matched saved searches are added to a second subset of saved searches. User identifiers associated with the second subset of saved searches are identified, and an instant notification message related to the job posting is sent to the computing devices of users associated with the identified user identifiers.

Embodiments improve computer-related technology by reducing system load in an existing system, leveraging the asynchronous nearline matching system to: (1) instantly send a notification to a user without delay; (2) reduce computer resource consumption; and (3) improve computer processing efficiency by eliminating repeated electronic communications that are otherwise required to solicit or match jobs to user's search queries. Experiments have shown that, using embodiments described herein, computer resources are reduced by one to two orders of magnitude compared to a traditional approach that would achieve near real-time (or “instant”) notifications.

A prior practice requires excessive use of computer processing resources, such as CPU usage and memory, as well as network bandwidth due to the existing matching method of search query-to-job lookup. The prior practice matches each user's search query to millions of job postings or documents one-by-one, which requires significant query processing time and computing resources. The technical solution disclosed herein improves a job matching system by matching a single job posting to multiple saved searches of users when a job posting is received, enabling a “reverse lookup” or “search percolation,” and avoiding the need to run millions of queries every minute or running all queries against the job posting search stack, which results in saving computer processing resources and network bandwidth.

### EXAMPLE SYSTEM

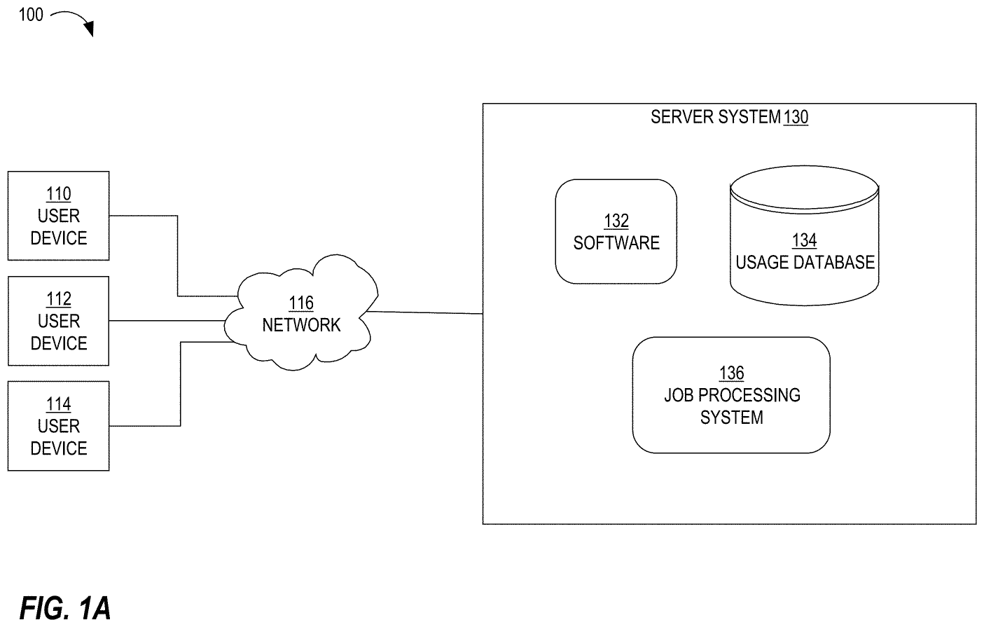

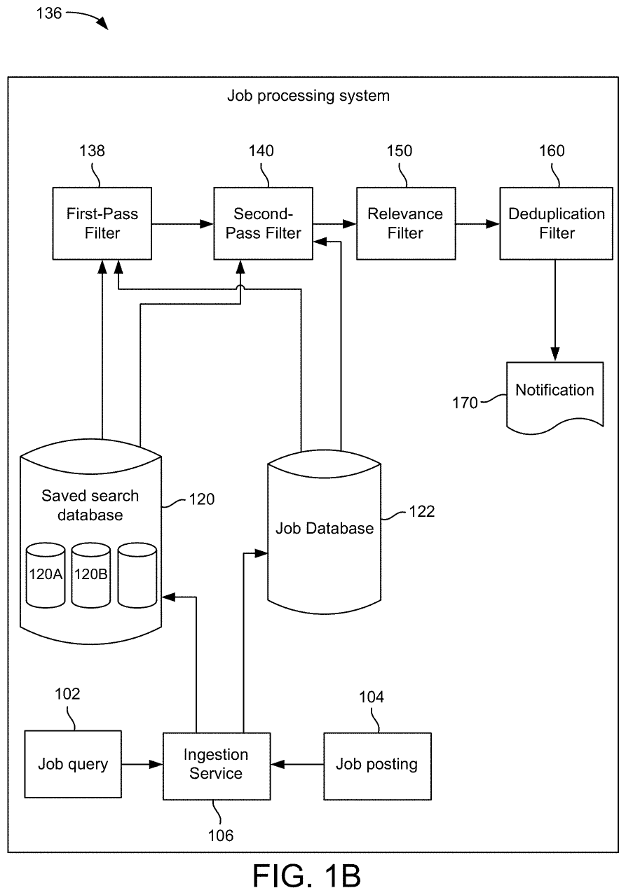

FIG. 1A is a block diagram that depicts an example job alert system 100, in an embodiment. Job alert system 100 includes user devices 110-114, a network 116, and a server system 130. User devices 110-114 are operated by end-users of software 132 and send data and/or requests to server system 130 over network 116 (such as a local area network (LAN), wide area network (WAN), or the Internet).

While only three user devices 110-114 are depicted, many more user devices may be communicatively coupled to server system 130. Examples of user devices 110-114 include desktop computers, laptop computers, tablet computers, wearable devices, video game consoles, and smartphones. Also, although only a single network 116 is depicted and described, user devices 110-114 may be communicatively connected to server system 130 through different computer networks.

Server system 130 comprises software 132, a usage database 134, a job processing system 136 which may be implemented in software, hardware, or any combination of software and hardware. Software 132 is usable by user devices 110-114. Software 132 may be a native application that user devices 110-114 individually download, install, and execute. Alternatively, a portion of software 132 may be a web application that is downloaded from server system 130 and executed within a web browser executing on user devices 110-114. To the extent that different versions of software 132 are developed and made available to users of user devices 110-114, different users may interact with different versions of software 132, even at the same time. However, each version implements similar features or the same set of basic features. Thus, some users of one version of software 132 might not have the option of interacting with a certain feature that is only available through a different version of software 132.

Usage database 134 includes information about the usage of software 132 by multiple users. Each time a user performs an action with respect to software 132 or otherwise interacts with features of software 132, that interaction is recorded and stored in usage database 134. Example actions or interactions include selecting a particular feature, selecting a particular view or tab, initiating a search query, viewing a user profile page, viewing a company profile page, scrolling through a feed of content items, selecting a particular type of content item (e.g., a job recommendation or a job posting), sending a message to another user, viewing a message from another user, responding to a message from another user, sending a connection request, accepting a connection request, and declining a connection request. For example, a record in usage database 134 may indicate a user identifier or member identifier, a feature of software 132 with which the user interacted, and a timestamp that indicates a date and/or a time of day.

FIG. 1B is a block diagram that depicts an example nearline job processing system 136 for processing new job postings and generating notifications, in an embodiment. Job processing system 136 comprises a first-pass filter 138, a second-pass filter 140, a relevance filter 150, a deduplication filter 160, a notification 170, a saved search database 120, a job database 122, a job search query 102, a job posting 104, and an ingestion service 106. First-pass filter 138, second-pass filter 140, relevance filter 150, deduplication filter 160, and ingestion service 106 may be implemented in software, hardware, or any combination of software and hardware.

Saved Search

In an embodiment, a search query is received via a user interface of an employment-based platform displayed on a user device 110-114. Job search query 102 may be user-specified criteria or user preferences indicated in previous job searches, such as the desired geographic location or a desired job, such as a specific job opportunity that is currently available or was previously available. Job search query 102 may be classified into attributes. Non-limiting examples of attributes in search queries include a job title, employment status, job posting company (e.g., recruiter or employer), geographic location information of the job provider (e.g., employer), job skills, industry, job functions, qualifications, education level, and experience level.

In an embodiment, a search query or a set of search queries can be saved as a saved search. A saved search may be stored in a standardized format. For example, a saved search comprises multiple attribute values, each attribute value corresponding to a known attribute. The attribute values in a saved search may be ordered based on a pre-established order of the known attributes. Each search query may be limited to specifying values for only the known attributes. The attribute value of each saved search may comprise an identification number for classification and standardization purposes. For example, the text “Software Engineer” for the attribute “Job Title” in a search query may be tagged with an Identification No. T352 and the text “Patent Attorney” for the same attribute may be tagged with an Identification No. T521. Saved searches and search queries may be stored in a search query database 120A.

The standardized information (e.g., taxonomy information) of the attributes may be stored in a hierarchy map that defines internal relationships of the attributes. For example, a location “Sunnyvale” may be mapped as a descendant of a location “Bay Area” in a hierarchy map for location. Accordingly, when a user searches for a “Sunnyvale” job, the search result may include job postings that specify or indicate “Bay area” as a location along with job postings that specify or indicate “Sunnyvale” as a location. In another example, a title “Java Engineer” may be mapped as a descendant of a title “Software Engineer.” The internal relationships of attributes can be used to expand or narrow a match between job postings and user queries.

In the context of standardization, saved searches can be ingested as a combination of standardized attributes. In one example, if a user searches for a combination of “Senior software engineer” and “Palo Alto,” then this particular combination of two different attribute types is grouped as a single combined saved search (e.g., User A's saved search No. A1=T82 AND L91). In another example, if the same user searches for a combination of “Java engineer” and “San Mateo,” then this combination of the attributes is grouped as another combined saved search with different standardized identification numbers (e.g., User A's saved search No. A2=T69 AND L103).

In some embodiments, each saved search is associated with a respective alert or notification. Each user may initiate one or more saved searches that are ingested through ingestion service 106 and linked to a corresponding alert or notification. The relationship between alerts and saved searches are inserted into a user database that resides in shared infrastructure storage. Saved searches may include varying numbers of attributes. Table A provides an example of ingested data that links alerts to saved searches. Table A shows that both alert 1 and alert 2 are linked to three attributes: title, company, and location. Alert 3 and alert 4 are linked to two attributes: title and location.

TABLE A
Example ingested saved search data

| Title | Company | Location | Alerts |
|---|---|---|---|
| Software Engineer | Linkedin | San Francisco | {alert1, alerts2, . . .} |
| Data Scientist | Linkedin | San Francisco | {alert4, alerts5, . . .} |
| Software Engineer | N/A | Seattle | {alert3, alerts4, . . .} |
| Title | Company | Location | Alerts |
| Software Engineer | Linkedin | San Francisco | {alert1, alerts2, . . .} |
| Data Scientist | Linkedin | San Francisco | {alert4, alerts5, . . .} |
| Software Engineer | N/A | Seattle | {alert3, alerts4, . . .} |

For the purpose of classification and standardization, a saved search may be linked to a user identifier associated with a user account at an employment-based platform such as a job posting platform. Each user is assigned a user identifier that uniquely identifies a particular user from other users. The employment-based platform stores data about online user actions performed by the particular user on the employment-based platform. Example online user actions include any user activity associated with content items posted on the employment-based platform. For example, when a user inputs a search query, the inputted search query can be tagged with a particular user identifier to create a relationship and indicate that the search query (and resulting saved search) is associated with a particular user. A saved search database table may be created to store the relationship information between a user ID and corresponding saved searches.

In an embodiment, in the saved search database table, a user's notification frequency setting can also be stored. For example, if a user wishes to receive a near real-time notification message, then the user may set a notification frequency to “instant” or “daily.” A user's notification channel setting may also be stored in the database table, as shown in Table B. In a related example, a user may indicate in which communication method or channel the user wishes to be notified of a new job posting. Example notification channels include an e-mail, text, push notification, or in-app banner.

TABLE B
Example saved search database table

| User ID | Saved Search | Notification frequency | Channel setting |
|---|---|---|---|
| 0001 | T82 AND L91 | Instant | E-mail |
| 0002 | T69 AND L103 | Weekly | In-app notification |

In one embodiment, a saved search table is stored in search query database 120A or in a separate database (saved search database) 120B for data scaling purposes. The standardized information, hierarchy map, standardized information of the attributes, and saved searches may be stored in shared infrastructure storage.

First Set of Criteria and Second Set of Criteria

In an embodiment, a saved search is divided into two sets of attribute values, referred to herein as a first set of criteria and a second set of criteria. In some embodiments, the first set of criteria includes a limited number of attributes (e.g., two) that are important to a user or to users generally, as evidenced in a search query log. For example, a first set of criteria may include a combination of geographic location and a job title. In a related example, the first set of criteria includes a combination of a company name and a geographic location. In another example, the first set of criteria includes a combination of a company name and a job title. The example first set of criteria is not limited to the above combination and may include any number of combinations of different attributes.

In some embodiments, a geographic location attribute is expanded to nearby locations if it is within a pre-defined range (e.g., 25 miles). For example, if a search query includes “Sunnyvale” as a geographic location attribute, then a job posting associated with a “Mountain View” location may be identified as a match.

In an embodiment, a standardized identification number with the highest confidence score may be selected for a company attribute and a job title attribute. In this context, a highest score means most accurately matched. In a related embodiment, company and job title attributes can be expanded based on standardized data for similar companies and job titles. For example, when a user searches for a “Software Engineer Linkedln” job, the resulting search query may include “Title (Software Engineer OR Senior Software Engineer) AND Company (LinkedIn OR Google).”

The second set of criteria may include attributes that are not included in the first set of criteria. In other words, the second set of criteria of a saved search may include all other attribute value(s) (or standardized attribute value(s)) that the user specified or selected for the corresponding search query. In some embodiments, the second set of criteria includes less important attributes for a user (or users generally) in searching or selecting a candidate job. For example, second set of criteria includes job skills, job function, employment type, experience level, or education level. The list is a non-exclusive list and can include any other attributes as needed.

Job Ingestion

A job posting 104 is received in a job processing system 136 when a company posts a new job opportunity on an employment-based platform. Each job may be consumed in a job matching stream implemented by job processing system 136 for a two-step filtering process. A job posting includes values for one or more attributes, such as a job title, one or more geographic locations, industry, one or more job functions, one or more job skills, experience level, or education level. Each job posting is ingested through an ingestion service 106 and formatted into a combination of standardized attributes. For example, a single job posting may be assigned a job identification number which uniquely identifies a particular job posting which comprises one or more different standardized attribute values indicated in the job description associated with the particular job posting: J1=L480+T3940+S405 (Job No. 1=Sunnyvale (location)+Software Engineer (title)+Linkedln (company)). The ingested job with standardized data may be stored in a job database 122 in shared infrastructure storage.

Ingestion of a job posting can be processed on an incoming basis. For example, when a new job posting is received at job processing system 136, job processing system 136 ingests the new job posting immediately rather than waiting for other job postings to be received for batch ingestion. This approach allows notifications to be provided to users as soon as a job posting is received and enables users to act on the right opportunities without delay.

First-Pass Filtering

First-pass filter 138 filters a newly ingested job posting against each of the saved searches to ensure that the newly ingested job posting meets explicit requirements for the attributes set by a user. The ingested job posting is compared against a first set of criteria of each of the saved searches to find a match. If the job posting satisfies a first set of criteria for at least one of the saved searches, then the job matching process continues to remain in the job matching stream. Matched saved searches are added to a first subset of saved searches, which may be filtered by a second-pass filter for further evaluation.

If the job posting does not satisfy the first set of criteria of any saved search, then the job posting is dropped and will no longer be processed. For example, if the job posting does not match the first set of criteria, for example, both job title and geographic location, then the job posting will not be notified to a user. In a related example, if a user has not provided a value of at least one attribute in the first set of criteria, then the same result will occur. Thus, only job postings that satisfy the first-pass filtering process will be passed onto a second-pass filtering process. This approach avoids a traditional or conventional way of running potentially millions of saved searches every minute or two to find a saved search that matches a new job posting.

If a job posting satisfies the first set of criteria, then a first subset of the saved searches is identified. Each saved search in the first subset is referred to herein as a “potential match,” and the first subset of saved searches is referred to herein as the “potential match set.” The potential match set is the output of first-pass filter 138 for a single job posting. The potential match set is a preliminary match between the job posting and saved searches. The potential match set is generated by matching the job posting against each attribute in the first set of criteria of saved searches. A preliminary match message may include a database table of matches with job identifiers, user identifiers, and saved search identifiers.

The first-pass filtering can be performed by traversing the relationship of the saved search and its attributes. For example, Job posting A may be broken into attributes (nodes), in one example, Title 1, Company 3, and Skill 5. From Job posting A, three edges can be generated in a graph of nodes; first edge from Job posting A to Title 1, second edge from Job posting A to Company 3, third edge from Job posting A to Skill 5. In one example, a first saved search (Query B with Title 1 and Skill 5) is received and a second saved search (Query C with Company 3 and Skill 100) is received. From the received saved searches, three new nodes (query B, query C and skill 100) are inserted in the graph and four new edges are generated; first new edge from Title 1 to Query B, second new edge from Skill 5 to Query B, third new edge from Company 3 to Query C, and fourth new edge from Skill 100 to Query C. When matching Job posting A, edges are traversed from Job positing A to find attribute nodes, Title 1, Company 3, and Skill 5 (these original attributes nodes are referred to as “attribute node set”). From the attribute node set, edges are traversed to find queries, from Title 1 to Query B, Skill 5 to Query B, Company 3 to Query C, leaving two candidate queries for Job posting A, Query B, and Query C.

In one embodiment, traversing is performed backward one query at a time. For example, from Query B, two edges can be found; one edge from Query B pointing to Title 1, another edge from Query B pointing to Skill 5. Since the nodes to which these edges point are attribute nodes that are in the original “attribute node set,” Query B is determined to be a match for Job Posting A.

For Query C, two edges can be found; one edge from Query C pointing to Company 3 and another edge from Query C pointing to Skill 100. Because only Company 3 is present in the original “attribute node set” and Skill 100 is not present in the “attribute node set,” Query C does not match Job posting A.

More attribute types used in this traversal method allows finding a larger candidate set of queries. However, finding more queries may be more computationally expensive. To have a balance between computation resources or cost and the ability to find the largest number of queries, administrators of job posting system 136 performs data analysis to choose which attributes to use in the traversal method.

Second-Pass Filtering

A second-pass filter 140 filters a job posting against a second set of criteria of the potential match set (i.e., the first subset of saved searches). The attributes of the potential match set that are not in the first set of criteria are included in the second set of criteria. For example, if job skill is an attribute in the second set of criteria and the new job posting includes at least one value for job skill, then the job skill attribute is in the second set of criteria. For each potential match in the potential match set, second-pass filter 140 matches all the remaining attributes that are associated with a job posting against a second set of criteria of the potential match. In other words, every attribute value in the second set of criteria needs to match the attribute values in the job posting.

In an embodiment, if all the attribute values of a “potential match” match the corresponding attribute values of the job posting, then the corresponding saved search is identified as output of the second-pass filtering. Each such saved search is referred to herein as an “exact match.” The output of second-pass filter 140 for a single job posting may include multiple exact matches, referred to as an “exact match set.” The second set of criteria may include employment status, job skills, industry, job functions, qualifications, education level, or experience level. The list herein is non-limiting and can include other attributes of choice.

If the job posting does not satisfy the second set of criteria of any potential match, then the job posting is dropped and will no longer remain in the job matching stream. For example, if a potential match identifies job skill identifier 10 and the job posting does not include the job skill identifier 10, then it is determined that the job posting is not relevant to the specific interest of the user corresponding to the potential match. Thus, even if this job posting satisfies the first set of criteria of the potential match, the user will not be notified of the job posting.

Relevance Filtering

In an embodiment, job processing system 136 does not include relevance filter 150. In an alternative embodiment, job processing system 136 includes relevance filter 150. Relevance filter 150 provides a quantitative measurement of a likelihood of a user performing an action associated with a notification regarding a specific job posting. Example actions include selecting the notification, viewing a web page that provides details about the corresponding job opportunity, applying for the job opportunity, contacting the job poster, and accepting an offer of employment from the corresponding job provider (which may be different than the job poster).

Relevance filter 150 calculates a relevance score for each user corresponding to an exact match in an exact match set. Thus, if there are ten exact matches given a job posting, then ten relevance scores are generated, one for each job posting-user-query triplet. Relevance filter 150 may implement a rule-based model or a machine-learned model (i.e., using one or more machine learning algorithms) in order to calculate the relevance score. A relevance score may indicate a likelihood of a user performing one of the example actions relative to a job posting, such as submitting a resume on an employment-based platform or contacting an employer. An example of a machine-learned model is one that is trained using training data that includes, for each training instance corresponding to a presentation of a job posting to a particular user, values of features of the particular user, values of features of the job posting, and a label that indicates whether the particular user submitted a resume to the poster of job posting. Examples of supervised machine learning algorithms to train the machine-learned model include regression and classification.

The one or more machine learning algorithms may train the model to optimize for one of the example actions, such as applications for a job posting. In one example, embeddings (or vectors of real numbers) are generated for entities referenced in a graph of entities, such as organizations and users. The embeddings quantify and categorize semantic similarities between entities based on their properties in large samples of graph data in which the entities are referenced. The more that two entities appear adjacent in a graph of entities from which embeddings are generated, the more their respective embeddings will be similar. If a job posting is not an entity in the graph, then an embedding may be generated for the job posting by aggregating embeddings of components of the job posting, such as an employer (or organization) referenced in the job posting, a job title referenced in the job posting, and skills referenced in the job posting. Once embeddings are generated for job postings and users, if an embedding is available for the job posting and an embedding is available for a user, then a cosine similarity between the two embeddings may be calculated to determine the relevance score.

The relevance score can be calculated based on historical user data, such as job submission history, job viewing history, or communication history with potential employers. In one embodiment, the relevance score can be calculated using a global model based on similar users' historical data. For example, if a user is a “Software Engineer” in “San Francisco,” a set of similar users such as “Senior Software Engineer” in “South San Francisco” may be identified, and the historical data of the example actions of the set of similar users may be identified. Based on the historical data of the set of similar users, a global model relevant to this particular user may be trained. In another embodiment, the relevance score can be calculated using a member model. The global model may differ from a member model in that the member model is trained based on training data for a particular user. For example, the member model may be trained using data for a particular member such as a particular member's title history, particular member's geographic location history, particular member's current job function history, or particular member's current job geolocation history.

For optimization purposes, if a relevance score for a job posting-exact match pair is above a threshold score, then data about the job posting is sent to a notification system 170. In one embodiment, a threshold score is selected through the data analysis by collecting the score distribution. For example, the relationship between the notification volume and the relevance score is analyzed, and an optimal threshold score is selected using a set of collected data and a set of experiment data. If the relevance score for a job posting-exact match pair is below the threshold score, then data about or identifying the job posting is not sent to the notification system 170. In this optimization context, relevance filter 150 acts as a throttler of potential notifications.

Deduplication Filtering

In an embodiment, deduplication filter 160 filters out duplicated jobs that a user previously applied, viewed, or saved. For example, if a user was notified of a job posting and then the job posting was re-posted by the same employer, then a notification about the re-posting is dropped since the user has already been notified of the job posting. In another embodiment, deduplication filter 160 filters out jobs that a user did not previously apply or save. For example, if a particular job posting was viewed by a user previously, but the user was not interested in that job posting and did not apply or save that job posting, then the user will not be notified of the particular job posting. As part of deduplication filter 160, a hash may be persisted for a job. Thus, for each job posting that a user views or clicks on, the user may be associated with a hash value that is generated based on attributes of the job posting. Additionally or alternatively, a job posting identifier is stored in associated with a user for each job posting with which the user interacts.

Notification System

Notification system 170 generates a notification about a job posting. Once data about a job posting reach notification system 170, a notification or alert may be generated through a communication channel that a user has specified. A notification is sent to a computing device of a user associated with an exact match. To maximize efficiency in providing relevant notifications, a limited number of notifications (e.g., one) per a saved search over a certain period of time (e.g., in one day) can be sent to a user. In this example, if a user's profile is associated with ten saved searches, then the user may receive a maximum of ten notifications per day, one for each saved search.

In one embodiment, a maximum number of notifications generated each day may differ based on a communication channel. For example, in order to optimize the user experience, the “one job posting per saved search per day” notification generation rule may apply only to certain communication channels such as “InApp” notifications, but not “Push Notifications.” Thus, a user may receive a maximum of ten “InApp” notifications per day, one for each saved search, but may only receive two “Push Notifications” per day.

In some embodiments, a near real-time notification is only generated and sent if a user's notification frequency setting is set to “instant,” meaning near real-time. The frequency setting indicates how often a user wishes to be notified of a job posting. If a user chooses not to receive an instant job posting notification, then a notification is not sent to a user even though job processing system 136 determines that a particular job posting is relevant to the user's interest. In that case, the notification may be included in a daily job alert and provided to a user in a standard batch job alert with a list of relevant jobs aggregated over time, rather than a near real-time notification targeted to one job posting that is the most relevant to a user. For example, if the frequency setting is set to “weekly” or “monthly,” then a relevant job posting may be included in a job search alert email (that is sent weekly or monthly) with a list of other relevant job recommendations.

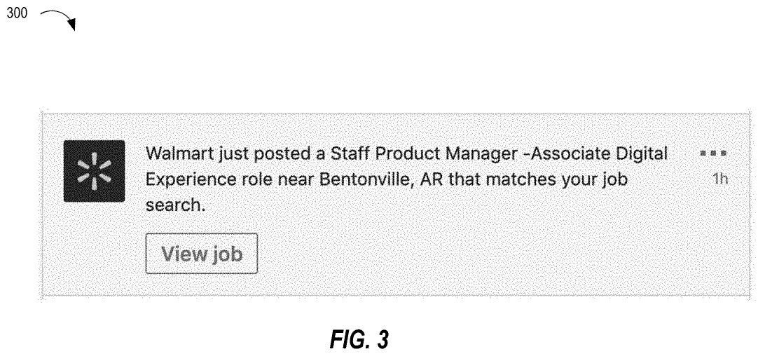

Depending on the user setting and preferences, a notification can be sent in multiple communication channels, such as e-mail, text, push notification, or in-app banner. FIG. 3 shows one example notification 300 that is provided to a computing device associated with a user. In this example, an in-app banner is used as a notification message associated with a new job posting where the first criteria include a company attribute value (i.e., “Walmart”), a title attribute (i.e., “Staff Product Manager”), and a geographic location attribute (i.e., “Bentonville, Ark.”). This is one type of exemplary user interface notifications, and other types of notifications can be sent to user devices 110-114 depending on the setting and preferences.

Procedural Overview

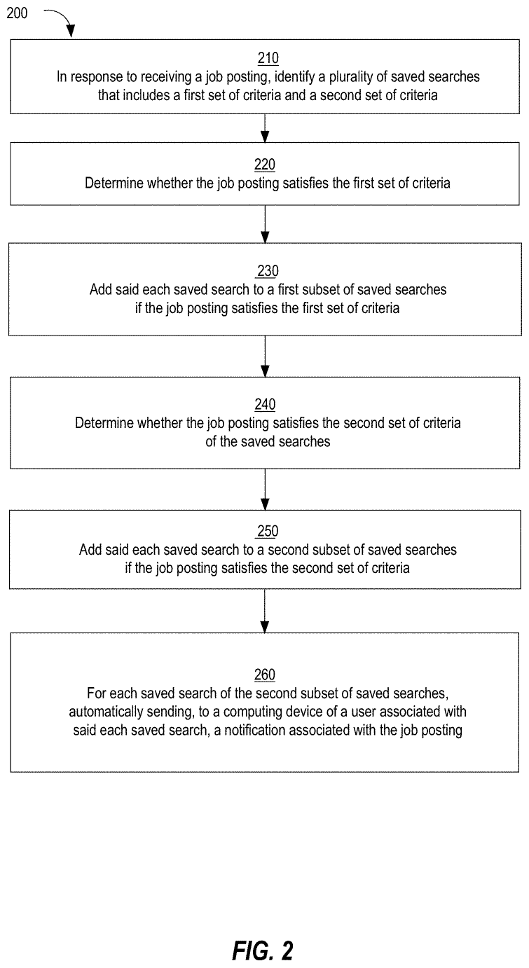

FIG. 2 is a flow diagram that depicts an example process 200 for generating asynchronous near real-time notifications for career opportunities, in an embodiment. Process 200 may be implemented by different components of job processing system 136.

At step 210, in response to receiving a job posting, a plurality of saved searches is identified. Each saved search in the plurality of saved searches is associated with a user and may be associated with a different search query set associated with a user. A saved search comprises one or more queries corresponding to different attributes.

At step 220, for each saved search of the plurality of saved searches, first-pass filter 138 determines whether the job posting satisfies the first set of criteria. In this step 220, job processing system 136 matches the job posting against each attribute of the first set of criteria of saved searches to determine a potential match.

At step 230, for each saved search of the plurality of saved searches, if the job posting satisfies the first set of criteria of the saved search, then each saved search is added to a first subset of saved searches. The first subset of saved searches is a subset of the plurality of saved searches that matches the first criteria. For example, if a job posting includes “Sunnyvale”+“Accountant,” and user A's query set (saved search) includes a “Sunnyvale”+“Software Engineer” then the job posting is not determined to satisfy user A's first criteria, and user A's saved search is not included in the first subset of saved searches.

At step 240, for each saved search of the first subset of saved searches, second-pass filter 140 determines whether the job posting satisfies the second set of criteria of the saved searches. Second-pass filter 140 is triggered only when a job posting has at least one potential match determined by first-pass filter 138.

At block 250, for each saved search of the first subset of saved searches [or potential matches], if the job posting satisfies the second set of criteria, each saved search is added to a second subset of saved searches. The second set of criteria can be matched with different levels of granularity. In one embodiment, a finer granularity may be adopted; all the remaining attributes of the job posting needs to match with the second criteria of saved searches in order for first subset of saved searches to be added to the second subset of saved searches. In another embodiment, a relatively coarse granularity has been adopted; queries can be relaxed a bit that similar queries are considered to be an exact match, and those may be included in the second subset of saved searches.

For each saved search of the second subset of saved searches, relevance filter 150 is programmed to calculate a corresponding relevance score based on the similarity between (a) one or more attributes of a user associated with each of the second subset of saved searches and (b) one or more attributes of the job posting. The relevance score provides a quantitative measurement of a likelihood of a user applying for the job posting based on the similarity between the current user's job and the job posting. The relevance score may also be calculated based on historical user data such as viewing history, applying history, communication history with potential employers.

At step 260, for each saved search of the second subset of saved searches, a notification associated with the job posting is automatically sent to a computing device of a user associated with said each saved search of the second subset of saved searches. Step 260 may be performed by notification system 170.

In an embodiment, if a relevance score of an exact match is above a threshold score, then each saved search is added to a third subset of saved searches. The third subset of saved searches may be processed by deduplication system 160 for further evaluation.

Deduplication system 160 determines whether a job posting in the job posting stream process has been sent to a computing device of a particular user associated with the third subset of saved searches. If a job posting has already been viewed, applied to, or sent as a notification to the user, then deduplication system 160 may determine that the user has already been notified of the job posting and remove the saved search of the user from the third subset of saved searches. This filtering approach ensures that a user is not notified twice of the same job posting and only receives notifications of new job postings that the user has not seen before. In an embodiment, a notification of the job posting is sent to a computing device of a user associated with each of the third subset of saved searches.

Use Case: Online Service

Job seekers are always seeking new and fresh job opportunities and wish to be on the front lines of the hiring process. In modern society, users of employment-oriented services can benefit from such services by visiting those employment-oriented services' webpages and learning about potential opportunities. Because there are hundreds of jobs that may be related to a particular job opportunity that a user is seeking and each job opportunity is quickly filled in a digital society, it is important to identify the most relevant job opportunity in a timely manner. To do so, a notification system that instantly notifies users about a new, fresh, and relevant job opportunity is critical in the job application process. Embodiments described herein generate instant notification messages of a new and relevant job posting to users of employment-oriented services and allow them to learn about such opportunities, and apply for those jobs promptly before other potential candidates while significantly reducing the consumption of computing resources.

Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

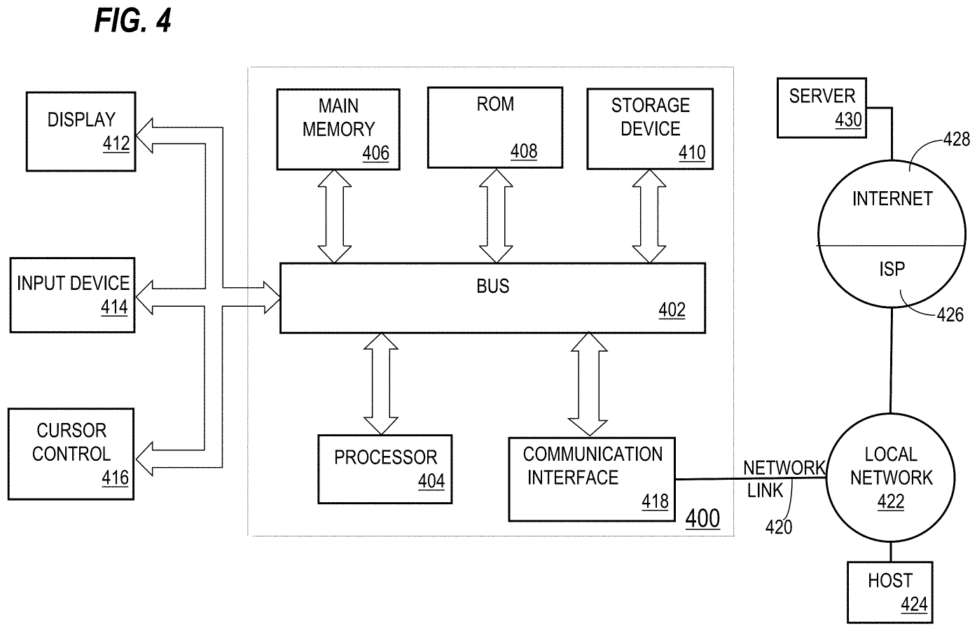

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
in response to receiving a job posting, initiating a near real-time notification generation process by:
identifying, in the job posting, a first set of attribute values that corresponds to a first set of attributes;
for each saved search of a plurality of saved searches:
determining whether the job posting satisfies a first set of search criteria of said each saved search;
wherein determining whether the job posting satisfies the first set of search criteria of said each saved search comprises determining whether the first set of attribute values matches the first set of search criteria of said each saved search;
adding said each saved search to a first subset of saved searches if the job posting satisfies the first set of search criteria;
for each saved search of the first subset of saved searches:
identifying, in the job posting, a second set of attribute values that corresponds to a second set of attributes that is different than the first set of attributes;
determining whether the job posting satisfies a second set of search criteria of said each saved search;
wherein determining whether the job posting satisfies the second set of search criteria of said each saved search comprises determining whether the second set of attribute values matches the second set of search criteria of said each saved search;
adding said each saved search to a second subset of saved searches if the job posting satisfies the second set of search criteria;
for each saved search of the second subset of saved searches:
automatically generating a near real-time notification associated with the job posting;
sending, to a computing device of a user associated with said each saved search, the near real-time notification associated with the job posting.

2. The computer-implemented method of claim 1, further comprising:
for a particular saved search of the second subset of saved searches:
calculating a relevance score based on similarity between (1) one or more attributes of a user associated with the particular saved search and (2) one or more attributes of the job posting;
determining whether the relevance score is above a threshold score;
automatically sending the notification associated with the particular saved search only if the relevance score is above the threshold score.

3. The computer-implemented method of claim 1, further comprising:
for a particular saved search of the second subset of saved searches:
determining whether data about the job posting has already been sent to a computing device of a particular user associated with the particular saved search;
removing the particular saved search from the second subset of saved searches in response to determining that the data about the job posting has already been sent to the computing device of the particular user.

4. The computer-implemented method of claim 1, further comprising:
for a first saved search of the second subset of saved searches:
determining a first type of communication channel specified by a first user associated with the first saved search;
sending a first notification about the job posting through the first type of communication channel;
for a second saved search of the second subset of saved searches:
determining a second type of communication channel specified by a second user associated with the second saved search, wherein the second type is different than the first type;
sending a second notification about the job posting through the second type of communication channel.

5. The computer-implemented method of claim 1, further comprising:
for each saved search of the second subset of saved searches:
determining a frequency setting specified by a user associated with said each saved search;
sending the notification to the computing device is based on the determination that the frequency setting is set to instant.

6. The computer-implemented method of claim 1, further comprising:
receiving the job posting comprising a plurality of attribute values;
ingesting the job posting by:
identifying an attribute value of an attribute in the set of attributes;
determining a standardized identifier for the attribute value;
storing the job posting with the standardized identifier for the respective value in a database.

7. The computer-implemented method of claim 1, further comprising:
receiving a search query from a first user, the search query including a set of attributes;
identifying a corresponding value associated with each of the set of attributes;
determining a standardized identifier for the corresponding value;
associating the standardized identifier with a user identification associated with the first user;
storing the user identifier and the standardized identifier as a first saved search.

8. The computer-implemented method of claim 1, wherein the first set of search criteria comprises two or more of attributes: a job title, a company, or a geographic location.

9. The computer-implemented method of claim 1, wherein each saved search in the plurality of saved searches is associated with a different search query associated with a user.

10. The computer-implemented method of claim 1, wherein the job posting is a first job posting, the method further comprising:
in response to receiving a second job posting that is different than the first job posting:
identifying, in the second job posting, a third set of attribute values that corresponds to the first set of attributes;
for each saved search of a plurality of saved searches:
determining whether the second job posting satisfies the first set of search criteria of said each saved search;
wherein determining whether the second job posting satisfies the first set of search criteria of said each saved search comprises determining whether the third set of attribute values matches the first set of search criteria of said each saved search;
adding said each saved search to a third subset of saved searches if the second job posting satisfies the first set of search criteria;
for each saved search of the third subset of saved searches:
identifying, in the second job posting, a fourth set of attribute values that corresponds to the second set of attributes;
determining whether the second job posting satisfies the second set of search criteria of said each saved search;
wherein determining whether the second job posting satisfies the second set of search criteria of said each saved search comprises determining whether the fourth set of attribute values matches the second set of search criteria of said each saved search;
adding said each saved search to a fourth subset of saved searches if the second job posting satisfies the second set of search criteria;
for a particular saved search in the fourth subset, determining to not send, to a computing device of a user that is associated with the particular saved search, a notification about the second job posting.

11. A system for generating notifications, the system comprising:
one or more processors;
one or more non-transitory computer-readable storage media storing sequences of instructions which, when executed by the one or more processors, cause:
in response to receiving a job posting, initiating a near real-time notification generation process by:
identifying, in the job posting, a first set of attribute values that corresponds to a first set of attributes;
for each saved search of a plurality of saved searches:
determining whether the job posting satisfies a first set of search criteria of said each saved search;
wherein determining whether the job posting satisfies the first set of search criteria of said each saved search comprises determining whether the first set of attribute values matches the first set of search criteria of said each saved search;
adding said each saved search to a first subset of saved searches if the job posting satisfies the first set of search criteria;
for each saved search of the first subset of saved searches:
identifying, in the job posting, a second set of attribute values that corresponds to a second set of attributes that is different than the first set of attributes;
determining whether the job posting satisfies a second set of search criteria of said each saved search;
wherein determining whether the job posting satisfies the second set of search criteria of said each saved search comprises determining whether the second set of attribute values matches the second set of search criteria of said each saved search;
adding said each saved search to a second subset of saved searches if the job posting satisfies the second set of search criteria;
for each saved search of the second subset of saved searches:
automatically generating a near real-time notification associated with the job posting;
sending, to a computing device of a user associated with said each saved search, the near real-time notification associated with the job posting.

12. The system of claim 11, wherein the instructions, when executed by the one or more processors, further cause:
for a particular saved search of the second subset of saved searches:
calculating a relevance score based on similarity between (1) one or more attributes of a user associated with the particular saved search and (2) one or more attributes of the job posting;
determining whether the relevance score is above a threshold score;
automatically sending the notification associated with the particular saved search only if the relevance score is above the threshold score.

13. The system of claim 11, wherein the instructions, when executed by the one or more processors, further cause:
for a particular saved search of the second subset of saved searches:
determining whether data about the job posting has already been sent to a computing device of a particular user associated with the particular saved search;
removing the particular saved search from the second subset of saved searches in response to determining that the data about the job posting has already been sent to the computing device of the particular user.

14. The system of claim 11, wherein the instructions, when executed by the one or more processors, further cause:
for a first saved search of the second subset of saved searches:
determining a first type of communication channel specified by a first user associated with the first saved search;
sending a first notification about the job posting through the first type of communication channel;
for a second saved search of the second subset of saved searches:
determining a second type of communication channel specified by a second user associated with the second saved search, wherein the second type is different than the first type;
sending a second notification about the job posting through the second type of communication channel.

15. The system of claim 11, wherein the instructions, when executed by the one or more processors, further cause:
for each saved search of the second subset of saved searches:
determining a frequency setting specified by a user associated with said each saved search;
sending the notification to the computing device is based on the determination that the frequency setting is set to instant.

16. The system of claim 11, wherein the instructions, when executed by the one or more processors, further cause:
receiving the job posting comprising a plurality of attribute values;
ingesting the job posting by:
identifying an attribute value of an attribute in the set of attributes;
determining a standardized identifier for the attribute value;
storing the job posting with the standardized identifier for the respective value in a database.

17. The system of claim 11, wherein the instructions, when executed by the one or more processors, further cause:
receiving a search query from a first user, the search query including a set of attributes;
identifying a corresponding value associated with each of the set of attributes;
determining a standardized identifier for the corresponding value;
associating the standardized identifier with a user identification associated with the first user;
storing the user identifier and the standardized identifier as a first saved search.

18. The system of claim 11, wherein the first set of search criteria comprises two or more of attributes: a job title, a company, or a geographic location.

19. The system of claim 11, wherein each saved search in the plurality of saved searches is associated with a different search query associated with a user.

20. The system of claim 11, wherein the job posting is a first job posting, wherein the instructions, when executed by the one or more processors, further cause:
in response to receiving a second job posting that is different than the first job posting:
identifying, in the second job posting, a third set of attribute values that corresponds to the first set of attributes;
for each saved search of a plurality of saved searches:
determining whether the second job posting satisfies the first set of search criteria of said each saved search;
wherein determining whether the second job posting satisfies the first set of search criteria of said each saved search comprises determining whether the third set of attribute values matches the first set of search criteria of said each saved search;
adding said each saved search to a third subset of saved searches if the second job posting satisfies the first set of search criteria;
for each saved search of the third subset of saved searches:
identifying, in the second job posting, a fourth set of attribute values that corresponds to the second set of attributes;
determining whether the second job posting satisfies the second set of search criteria of said each saved search;
wherein determining whether the second job posting satisfies the second set of search criteria of said each saved search comprises determining whether the fourth set of attribute values matches the second set of search criteria of said each saved search;
adding said each saved search to a fourth subset of saved searches if the second job posting satisfies the second set of search criteria;
for a particular saved search in the fourth subset, determining to not send, to a computing device of a user that is associated with the particular saved search, a notification about the second job posting.
